(19) United States
(12) Patent Application Publication
(10) Pub. No.: US 2024/0244269 A1
(43) Pub. Date: Jul. 18, 2024

(54) METHOD, DEVICE, AND MEDIUM FOR VIDEO PROCESSING

(71) Applicant: Bytedance Inc., Los Angeles, CA (US)

(72) Inventors: Yue LI, Los Angeles, CA (US); Kai ZHANG, Los Angeles, CA (US); Li ZHANG, Los Angeles, CA (US)

(21) Appl. No.: 18/622,539

(22) Filed: Mar. 29, 2024

Related U.S. Application Data
(63) Continuation of application No. PCT/US22/77262, filed on Sep. 29, 2022.
(60) Provisional application No. 63/249,830, filed on Sep. 29, 2021.

(51) Int. Cl. H04N 19/80; H04N 19/105; H04N 19/139; H04N 19/157; H04N 19/176; H04N 19/46

(52) U.S. Cl. CPC H04N 19/80; H04N 19/105; H04N 19/139; H04N 19/157; H04N 19/176; H04N 19/46

(57) ABSTRACT

Embodiments of the present disclosure provide a solution for video processing. A method for video processing is proposed. The method comprises: filtering, according to a machine learning model during a conversion between a current video block of a video and a bitstream of the video, the current video block based on first information associated with one or multiple previously coded frames of the video; and performing the conversion based on the filtered current video block.

### CROSS-REFERENCE TO RELATED APPLICATIONS

This application is a continuation of International Application No. PCT/US2022/077262, filed on Sep. 29, 2022, which claims the benefit of U.S. Application No. 63/249,830 filed on Sep. 29, 2021. The entire contents of these applications are hereby incorporated by reference in their entireties.

### FIELD

Embodiments of the present disclosure relates generally to video coding techniques, and more particularly, to use of previously coded frames by a machine learning model.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally expected to be further improved.

### SUMMARY

Embodiments of the present disclosure provide a solution for video processing.

In a first aspect, a method for video processing is proposed. The method comprises: filtering, according to a machine learning model during a conversion between a current video block of a video and a bitstream of the video, the current video block based on first information associated with one or multiple previously coded frames of the video; and performing the conversion based on the filtered current video block. The method in accordance with the first aspect of the present disclosure make use of information from previously coded frames to filter the current block. In this way, coding performance can be further improved.

In a second aspect, an apparatus for processing video data is proposed. The apparatus for processing video data comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, a non-transitory computer-readable recording medium is proposed. The non-transitory computer-readable recording medium stores a bitstream of a video which is generated by a method performed by a video processing apparatus. The method comprises: filtering, according to a machine learning model, a current video block of the video based on first information associated with one or multiple previously coded frames of the video; and generating the bitstream based on the filtered current video block.

In a fifth aspect, a method for storing a bitstream of a video is proposed. The method comprises: filtering, according to a machine learning model, a current video block of the video based on first information associated with one or multiple previously coded frames of the video; generating the bitstream based on the filtered current video block; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of raster-scan slice partitioning of a picture;

FIG. 5 illustrates an example of rectangular slice partitioning of a picture;

FIG. 6 illustrates an example of a picture partitioned into tiles, bricks, and rectangular slices;

FIG. 7A illustrates a schematic diagram of coding tree blocks (CTBs) crossing the bottom picture border;

FIG. 7B illustrates a schematic diagram of CTBs crossing the right picture border;

FIG. 7C illustrates a schematic diagram of CTBs crossing the right bottom picture border;

FIG. 8 illustrates an example of encoder block diagram of VVC;

FIG. 9 illustrates a schematic diagram of picture samples and horizontal and vertical block boundaries on the 8×8 grid, and the nonoverlapping blocks of the 8×8 samples, which can be deblocked in parallel;

FIG. 10 illustrates a schematic diagram of pixels involved in filter on/off decision and strong/weak filter selection;

FIG. 11A illustrates an example of 1-D directional pattern for EO sample classification which is a horizontal pattern with EO class=0;

FIG. 11B illustrates an example of 1-D directional pattern for EO sample classification which is a vertical pattern with EO class=1;

FIG. 11C illustrates an example of 1-D directional pattern for EO sample classification which is a 135° diagonal pattern with EO class=2;

FIG. 11D illustrates an example of 1-D directional pattern for EO sample classification which is a 45° diagonal pattern with EO class=3;

FIG. 12A illustrates an example of a geometry transformation-based adaptive loop filter (GALF) filter shape of 5×5 diamond;

FIG. 12B illustrates an example of a GALF filter shape of 7×7 diamond;

FIG. 12C illustrates an example of a GALF filter shape of 9×9 diamond;

FIG. 13A illustrates an example of relative coordinator for the 5×5 diamond filter support in case of diagonal;

FIG. 13B illustrates an example of relative coordinator for the 5×5 diamond filter support in case of vertical flip;

FIG. 13C illustrates an example of relative coordinator for the 5×5 diamond filter support in case of rotation;

FIG. 14 illustrates an example of relative coordinates used for 5×5 diamond filter support;

FIG. 15A illustrates a schematic diagram of the architecture of the proposed convolutional neural network (CNN) filter where M denotes the number of feature maps and N stands for the number of samples in one dimension;

FIG. 15B illustrates an example of the construction of residual block (ResBlock) in the CNN filter of FIG. 15A;

FIG. 16 illustrates a flowchart of a method for video processing in accordance with some embodiments of the present disclosure; and

FIG. 17 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

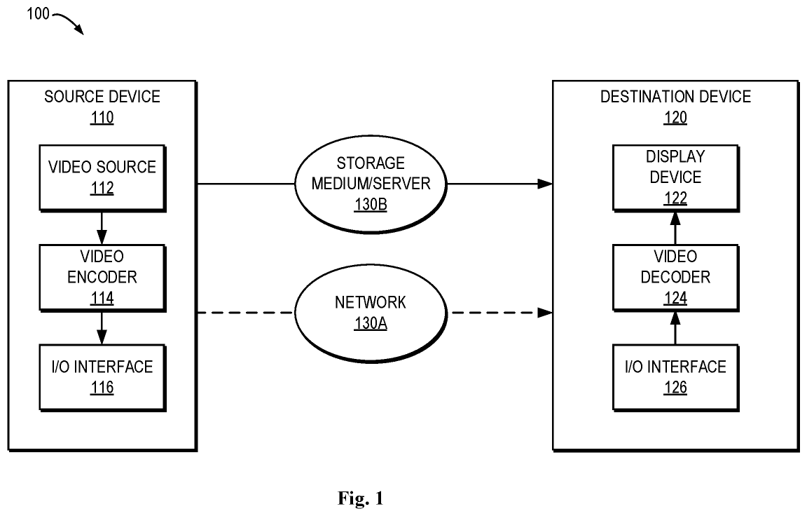

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

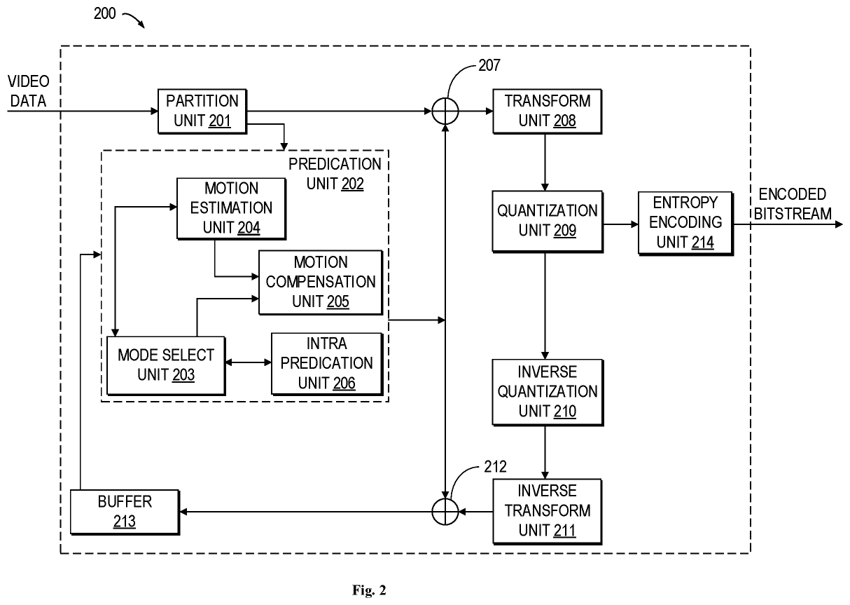

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

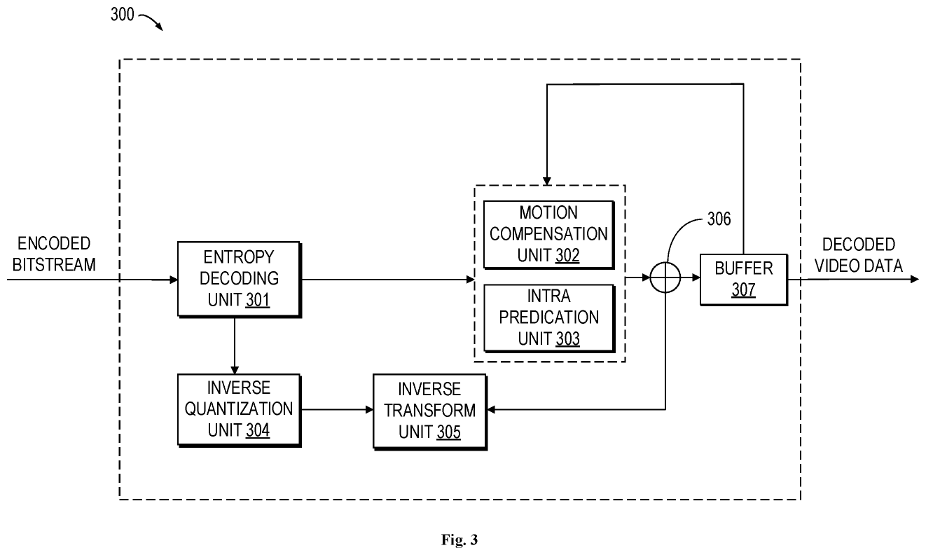

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

The embodiments are related to video coding technologies. Specifically, it is related to the loop filter in image/video coding. It may be applied to the existing video coding standard like High-Efficiency Video Coding (HEVC), Versatile Video Coding (VVC), or AVS3. It may be also applicable to future video coding standards or video codec or being used as post-processing method which is out of encoding/decoding process.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.
For video compression, the most frequently used color spaces are YCbCr and RGB.
YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries. Chroma subsampling is the practice of encoding images by implementing less resolution for chroma information than for luma information, taking advantage of the human visual system's lower acuity for color differences than for luminance.
2.1.1. 4:4:4
Each of the three Y′CbCr components have the same sample rate, thus there is no chroma subsampling. This scheme is sometimes used in high-end film scanners and cinematic post production.
2.1.2. 4:2:2
The two chroma components are sampled at half the sample rate of luma: the horizontal chroma resolution is halved. This reduces the bandwidth of an uncompressed video signal by one-third with little to no visual difference.
2.1.3. 4:2:0
In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.
A tile is divided into one or more bricks, each of which consisting of a number of CTU rows within the tile.
A tile that is not partitioned into multiple bricks is also referred to as a brick. However, a brick that is a true subset of a tile is not referred to as a tile.
A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

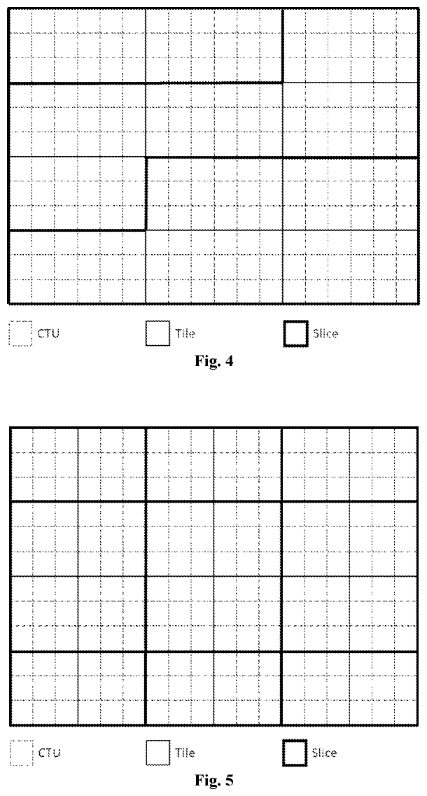

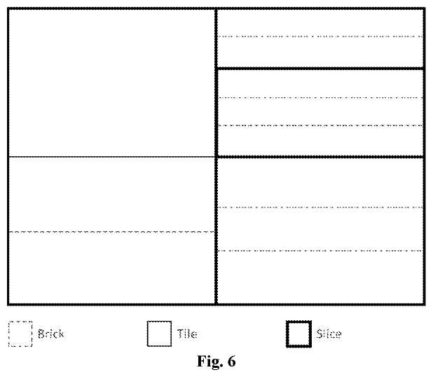

FIG. 4 shows an example of raster-scan slice partitioning of a picture, where the picture is divided into 12 tiles and 3 raster-scan slices. FIG. 4 illustrates a picture with 18 by 12 luma CTUs that is partitioned into 12 tiles and 3 raster-scan slices (informative).
FIG. 5 shows an example of rectangular slice partitioning of a picture, where the picture is divided into 24 tiles (6 tile columns and 4 tile rows) and 9 rectangular slices. FIG. 5 illustrates a picture with 18 by 12 luma CTUs that is partitioned into 24 tiles and 9 rectangular slices (informative).
FIG. 6 shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. FIG. 6 illustrates a picture that is partitioned into 4 tiles, 11 bricks, and 4 rectangular slices (informative).

### 2.2.1. CTU/CTB Sizes

In VVC, the CTU size, signaled in SPS by the syntax element log 2_ctu_size_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.
log 2_min_luma_coding_block_size_minus2 plus 2 specifies the minimum luma coding block size.
The variables Ctb Log 2SizeY, CtbSizeY, MinCbLog2SizeY, MinCbSize Y, MinTb Log 2SizeY, Max Tb Log 2Size Y, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, Pic WidthInSamplesC and PicHeightInSamplesC are derived as follows:

| | |
|---|---|
| CtbLog2SizeY = log2_ctu_size_minus2 + 2 | (7-9) |
| CtbSizeY = 1 << CtbLog2SizeY | (7-10) |
| MinCbLog2SizeY = log2_min_luma_coding_block_size_minus2 + 2 | (7-11) |
| MinCbSizeY = 1 << MinCbLog2SizeY | (7-12) |
| MinTbLog2SizeY = 2 | (7-13) |
| MaxTbLog2SizeY = 6 | (7-14) |
| MinTbSizeY = 1 << MinTbLog2SizeY | (7-15) |
| MaxTbSizeY = 1 << MaxTbLog2SizeY | (7-16) |
| PicWidthInCtbsY = Ceil( pic_width_in_luma_samples ÷ CtbSizeY ) | (7-17) |
| PicHeightInCtbsY = Ceil( pic_height_in_luma_samples ÷ CtbSizeY ) | (7-18) |
| PicSizeInCtbsY = PicWidthInCtbsY * PicHeightInCtbsY | (7-19) |
| PicWidthInMinCbsY = pic_width_in_luma_samples / MinCbSizeY | (7-20) |
| PicHeightInMinCbsY = pic_height_in_luma_samples / MinCbSizeY | (7-21) |
| PicSizeInMinCbsY = PicWidthInMinCbsY * PicHeightInMinCbsY | (7-22) |
| PicSizeInSamplesY = pic_width_in_luma_samples * pic_height_in_luma_samples | (7-23) |
| PicWidthInSamplesC = pic_width_in_luma_samples / SubWidthC | (7-24) |
| PicHeightInSamplesC = pic_height_in_luma_samples / SubHeightC | (7-25) |

### 2.2.2. CTUs in a Picture

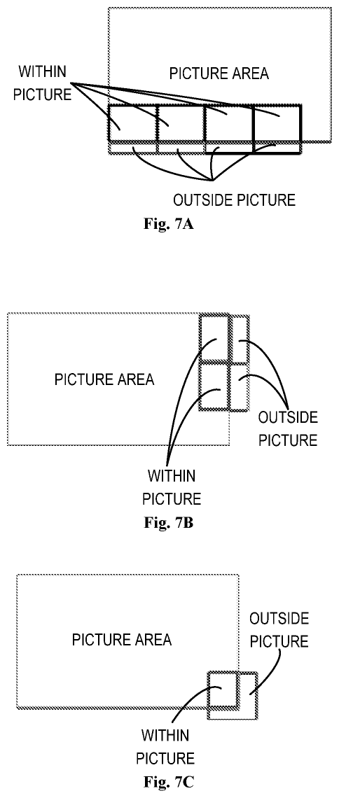

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIG. 7A, FIG. 7B and FIG. 7C, the CTB size is still equal to M×N, however, the bottom boundary/right boundary of the CTB is outside the picture. FIG. 7A shows CTBs crossing the bottom picture border where K=M, L<N. FIG. 7B shows CTBs crossing the right picture border where K<M, L=N. FIG. 7C shows crossing the right bottom picture border where K<M, L<N.

### 2.3. Coding Flow of a Typical Video Codec

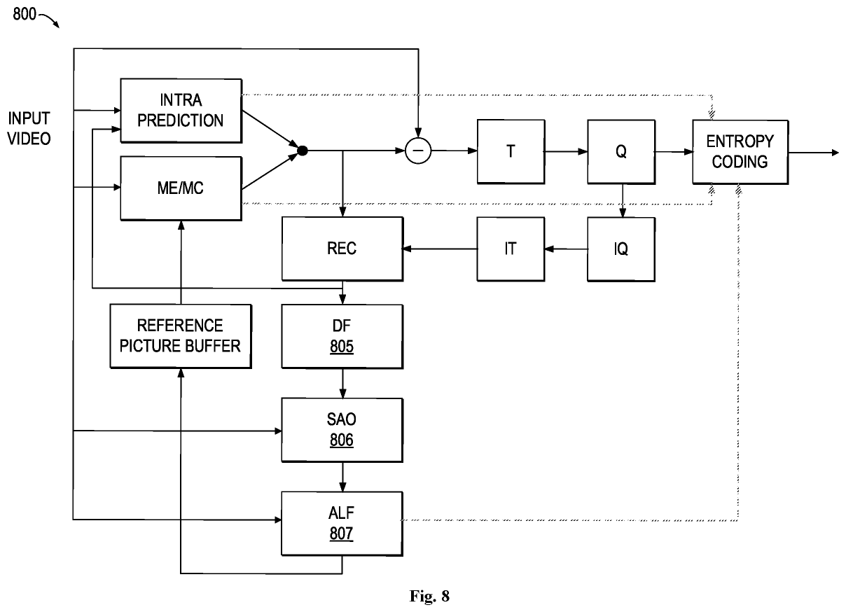

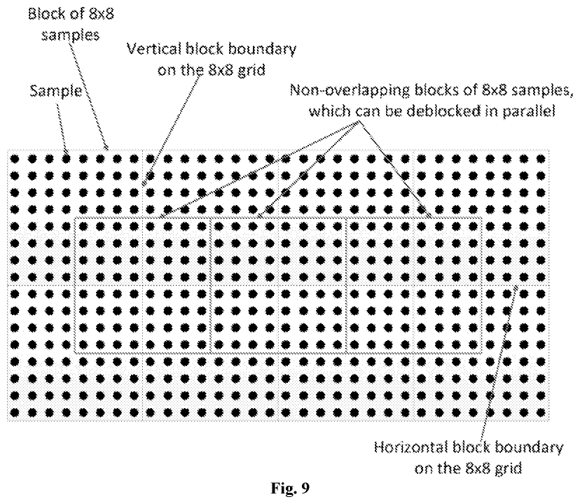

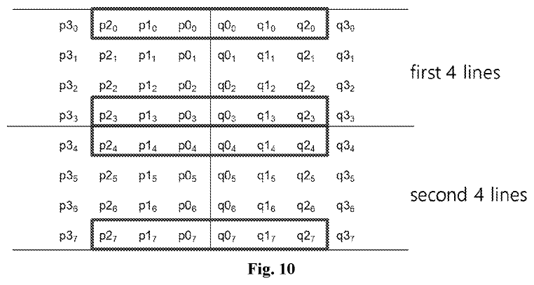

FIG. 8 shows an example of encoder block diagram 800 of VVC, which contains three in-loop filtering blocks: deblocking filter (DF) 805, sample adaptive offset (SAO) 806 and ALF 807. Unlike DF 805, which uses predefined filters, SAO 806 and ALF 807 utilize the original samples of the current picture to reduce the mean square errors between the original samples and the reconstructed samples by adding an offset and by applying a finite impulse response (FIR) filter, respectively, with coded side information signaling the offsets and filter coefficients. ALF 807 is located at the last processing stage of each picture and can be regarded as a tool trying to catch and fix artifacts created by the previous stages.

### 2.4. Deblocking Filter (DB)

### The Input of DB is the Reconstructed Samples Before In-Loop Filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order. FIG. 9 illustrates a schematic diagram of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS[xDᵢ][yDⱼ] (wherein [xDᵢ][yDⱼ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent blocks has | 1 | 1 | 1 |
| | non-zero transform coefficients | | | |
| 3 | Reference pictures or number of MVs (1 for uni-prediction, | 1 | N/A | N/A |
| | 2 for bi-prediction) of the adjacent blocks are different | | | |
| 2 | Absolute difference between the motion vectors of same | 1 | N/A | N/A |
| | reference picture that belong to the adjacent blocks is | | | |
| | greater than or equal to one integer luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent blocks has | 1 | 1 | 1 |
| | non-zero transform coefficients | | | |
| 6 | Prediction mode of adjacent blocks is different (e.g., one is | 1 | | |
| | IBC, one is inter) | | | |
| 5 | Both IBC and absolute difference between the motion | 1 | N/A | N/A |
| | vectors that belong to the adjacent blocks is greater than or | | | |
| | equal to one integer luma sample | | | |
| 4 | Reference pictures or number of MVs (1 for uni-prediction, | 1 | N/A | N/A |
| | 2 for bi-prediction) of the adjacent blocks are different | | | |
| 3 | Absolute difference between the motion vectors of same | 1 | N/A | N/A |
| | reference picture that belong to the adjacent blocks is | | | |
| | greater than or equal to one integer luma sample | | | |
| 1 | Otherwise | 0 | 0 | 0 |

### 2.4.3. Deblocking Decision for Luma Component

The deblocking decision process is described in this sub-section. FIG. 7 shows pixels involved in filter on/off decision and strong/weak filter selection.
Wider-stronger luma filter is filters are used only if all the Condition1, Condition2 and Condition 3 are TRUE.
The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

bSidePisLargeBlk = ((edge type is vertical and p₀ belongs to CU with
width >= 32) | | (edge type is horizontal
and p₀ belongs to CU with height >= 32))? TRUE: FALSE
bSideQisLargeBlk = ((edge type is vertical and q₀ belongs to CU with
width >= 32) | | (edge type is horizontal
and q₀ belongs to CU with height >= 32))? TRUE: FALSE

Based on bSidePisLargeBlk and bSideQisLargeBlk, the condition 1 is defined as follows.

### Condition1=(bSidePisLargeBlk∥bSidePisLargeBlk)? TRUE: FALSE

Next, if Condition 1 is true, the condition 2 will be further checked. First, the following variables are derived:

```
  - dp0, dp3, dq0, dq3 are first derived as in HEVC
  - if (p side is greater than or equal to 32)
      dp0 = ( dp0 + Abs( p5₀ − 2 * p4₀ + p3₀ ) + 1 ) >> 1
      dp3 = ( dp3 + Abs( p5₃ − 2 * p4₃ + p3₃ ) + 1 ) >> 1
  - if (q side is greater than or equal to 32)
      dq0 = ( dq0 + Abs( q5₀ − 2 * q4₀ + q3₀ ) + 1 ) >> 1
      dq3 = ( dq3 + Abs( q5₃ − 2 * q4₃ + q3₃ ) + 1 ) >> 1
Condition2 = (d < β) ? TRUE: FALSE
    where d= dp0 + dq0 + dp3 + dq3.
```

If Condition1 and Condition2 are valid, whether any of the blocks uses sub-blocks is further checked:

```
If (bSidePisLargeBlk)
  {
    If (mode block P == SUBBLOCKMODE)
      Sp =5
      else
      Sp =7
}
else
  Sp = 3
If (bSideQisLargeBlk)
  {
    If (mode block Q == SUBBLOCKMODE)
        Sq =5
      else
        Sq =7
    }
else
  Sq = 3
```

Finally, if both the Condition 1 and Condition 2 are valid, the proposed deblocking method will check the condition 3 (the large block strong filter condition), which is defined as follows.
In the Condition3 StrongFilterCondition, the following variables are derived:

```
  dpq is derived as in HEVC.
  sp₃ = Abs( p₃ − p₀ ), derived as in HEVC
  if (p side is greater than or equal to 32)
      if(Sp==5)
        sp₃ = ( sp₃ + Abs( p₅ − p₃ ) + 1) >> 1
      else
        sp₃ = ( sp₃ + Abs( p₇ − p₃ ) + 1) >> 1
  sq₃ = Abs( q₀ − q₃ ), derived as in HEVC
  if (q side is greater than or equal to 32)
    If(Sq==5)
      sq₃ = ( sq₃ + Abs( qₛ − q₃ ) +1) >> 1
    else
      sq₃ = ( sq₃ + Abs( q₇ − q₃ ) +1) >> 1
As in HEVC, StrongFilterCondition = (dpq is less than ( β >> 2 ), sp₃ +
sq₃ is less than
( 3*β >> 5 ), and Abs( p₀ − q₀ ) is less than ( 5 * t_{C} + 1 ) >> 1) ?
TRUE : FALSE.
```

### 2.4.4. Stronger Deblocking Filter for Luma (Designed for Larger Blocks)

Bilinear filter is used when samples at either one side of a boundary belong to a large block. A sample belonging to a large block is defined as when the width>=32 for a vertical edge, and when height>=32 for a horizontal edge.
The bilinear filter is listed below.
Block boundary samples pi for i=0 to Sp−1 and qᵢ for j=0 to Sq−1 (pi and qi are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) >> 6 ) , clipped to {p}_{i} \pm {tcPD}_{i}$$

$${q}_{j}^{′} = ( {g}_{j} * {Middle}_{s 𝔱} + ( 64 - {g}_{j} ) * {Q}_{s} + 32 ) >> 6 ) , clipped to {q}_{j} \pm {tcPD}_{j}$$

where tcPDᵢ and tcPDⱼ term is a position dependent clipping described in Section 2.4.7 and gⱼ, fᵢ, Middle_{s,t}, Pₛ and Qₛ are given below:

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.
In the first decision, boundary strength (bS) is modified for chroma filtering and the conditions are checked sequentially. If a condition is satisfied, then the remaining conditions with lower priorities are skipped.
Chroma deblocking is performed when bS is equal to 2, or bS is equal to 1 when a large block boundary is detected.
The second and third condition is basically the same as HEVC luma strong filter decision as follows.
In the second condition:
d is then derived as in HEVC luma deblocking.
   The second condition will be TRUE when d is less than β.
   In the third condition StrongFilterCondition is derived as follows:
dpq is derived as in HEVC.

$${sp}_{3} = Abs ( {p}_{3} - {p}_{0} ) , derived as in HEVC$$

$${sq}_{3} = Abs ( {q}_{0} - {q}_{3} ) , derived as in HEVC$$

As in HEVC design, StrongFilterCondition=(dpq is less than (β>>2), sp₃+sq₃ is less than (β>>3), and Abs(p₀−q₀) is less than (5*t_{C}+1)>>1).

### 2.4.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) >> 3$$

$${p}_{1}^{′} = ( 2 * {p}_{3} + {p}_{2} + 2 * {p}_{1} + {p}_{0} + {q}_{0} + {q}_{1} + 4 ) >> 3$$

$${p}_{0}^{′} = ( {p}_{3} + {p}_{2} + {p}_{1} + 2 * {p}_{0} + {q}_{0} + {q}_{1} + {q}_{2} + 4 ) >> 3$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.
For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$Tc 7 = \{ 6 , 5 , 4 , 3 , 2 , 1 , 1 \} ; Tc 3 = \{ 6 , 4 , 2 \} ;$$

$$tcPD = ( Sp == 3 ) ? Tc 3 : Tc 7 ;$$

$$tcQD = ( Sq == 3 ) ? Tc 3 : Tc 7 ;$$

For the P or Q boundaries being filtered with a short symmetrical filter, position dependent threshold of lower magnitude is applied:

$$Tc 3 = \{ 3 , 2 , 1 \} ;$$

Following defining the threshold, filtered p′ᵢ and q′ᵢ sample values are clipped according to tcP and tcQ clipping values:

$${p}_{i}^{″} = Clip 3 ( {p}_{i}^{′} + {tcP}_{i} , {p}_{i}^{′} - {tcP}_{i} , {p}_{i}^{′} ) ; \\ {q}_{j}^{″} = Clip 3 ( {q}_{j}^{′} + tc {Q}_{j} , {q}_{j}^{′} - {tcQ}_{j} , {q}_{j}^{′} ) ;$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.
Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 ∥ edge == (orthogonalLength − 2) ∥ edge == (56 / 4) ∥
    edge == (72 / 4))
        Sp = Sq = 2;
      else
        Sp = Sq = 3;
  else
      Sp = Sq = bSideQisLargeBlk ? 5:3
}
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

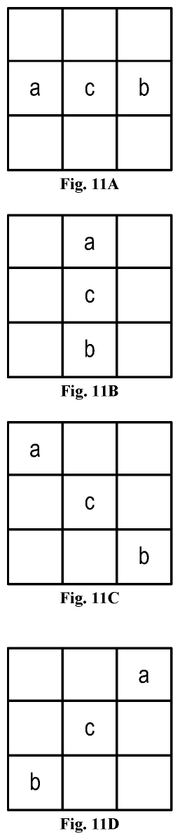

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.
Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal. FIGS. 11A-11D show four 1-D directional patterns for EO sample classification: horizontal (EO class=0) in FIG. 11A, vertical (EO class=1) in FIG. 11B, 135° diagonal (EO class=2) in FIG. 11C, and 45° diagonal (EO class=3) in FIG. 11D.
For a given EO class, each sample inside the CTB is classified into one of five categories. The current sample value, labeled as “c,” is compared with its two neighbors along the selected 1-D pattern. The classification rules for each sample are summarized in Table 3. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c<a and c<b |
| 2 | ( c < a && c==b) \|\|(c == a && c < b) |
| 3 | ( c > a && c==b) \|\|(c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.
In the JEM, a geometry transformation-based adaptive loop filter (GALF) with block-based filter adaption is applied. For the luma component, one among 25 filters is selected for each 2×2 block, based on the direction and activity of local gradients.

### 2.6.1. Filter Shape

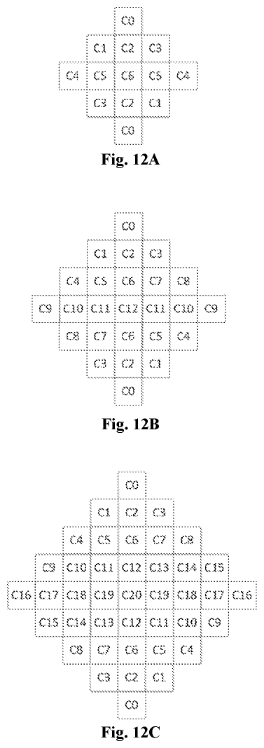

In the JEM, up to three diamond filter shapes (as shown in FIGS. 12A-12C) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used. FIG. 12A shows the 5×5 diamond shape, FIG. 12B shows the 7×7 diamond shape and FIG. 12C shows the 9×9 diamond shape.

### 2.6.1.1. Block Classification

Each 2×2 block is categorized into one out of 25 classes. The classification index C is derived based on its directionality D and a quantized value of activity Â, as follows:

$$C = 5 D + \hat{A} . \qquad ( 1 )$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 4 )$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert \qquad ( 5 )$$

Indices i and j refer to the coordinates of the upper left sample in the 2×2 block and R(i, j) indicates a reconstructed sample at coordinate (i, j).
Then D maximum and minimum values of the gradients of horizontal and vertical directions are set as:

$${g}_{h , v}^{m ax} = max ( {g}_{h} , {g}_{v} ) , {g}_{h , v}^{m i n} = min ( {g}_{h} , {g}_{v} ) , \qquad ( 6 )$$

and the maximum and minimum values of the gradient of two diagonal directions are set as:

$${g}_{d 0 , d 1}^{ma x} = max ( {g}_{d 0} , {g}_{d 1} ) , {g}_{d 0 , d 1}^{m i n} = min ( {g}_{d 0} , {g}_{d 1} ) , \qquad ( 7 )$$

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.
   The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.
For both chroma components in a picture, no classification method is applied, i.e. a single set of ALF coefficients is applied for each chroma component.

### 2.6.1.2. Geometric Transformations of Filter Coefficients

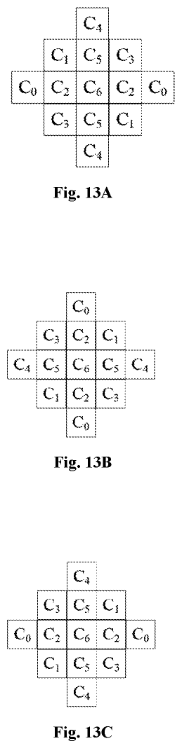

FIG. 13A shows relative coordinator for the 5×5 diamond filter support in case of diagonal. FIG. 13B shows relative coordinator for the 5×5 diamond filter support in case of vertical flip. FIG. 13C shows relative coordinator for the 5×5 diamond filter support in case of rotation.
Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality.
Three geometric transformations, including diagonal, vertical flip and rotation are introduced:

$$Diagonal : {f}_{D} ( k , l ) = f ( l , k ) , \\ Vertical flip : {f}_{V} ( k , l ) = f ( k , K - l - 1 ) , \\ Rotation : {f}_{R} ( k , l ) = f ( K - l - 1 , k ) . \qquad ( 9 )$$

where K is the size of the filter and 0≤k, l≤K−1 are coefficients coordinates, such that location (0,0) is at the upper left corner and location (K−1,K−1) is at the lower right corner. The transformations are applied to the filter coefficients f (k, l) depending on gradient values calculated for that block. The relationship between the transformation and the four gradients of the four directions are summarized in Table 4. FIGS. 13A-13C shows the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.
To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.
Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f (k, l) can still be sent for this class in which case the coefficients of the filter which will be applied to the reconstructed image are sum of both sets of coefficients.
The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i, j) within the block is filtered, resulting in sample value R′(i, j) as shown below, where L denotes filter length, f_{m,n} represents filter coefficient, and f (k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

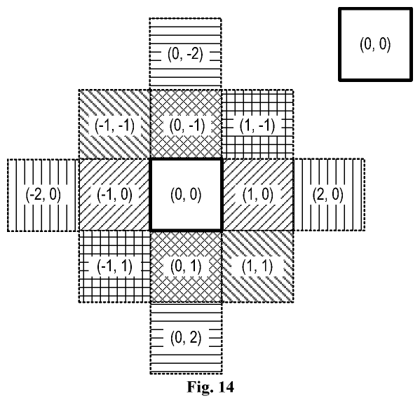

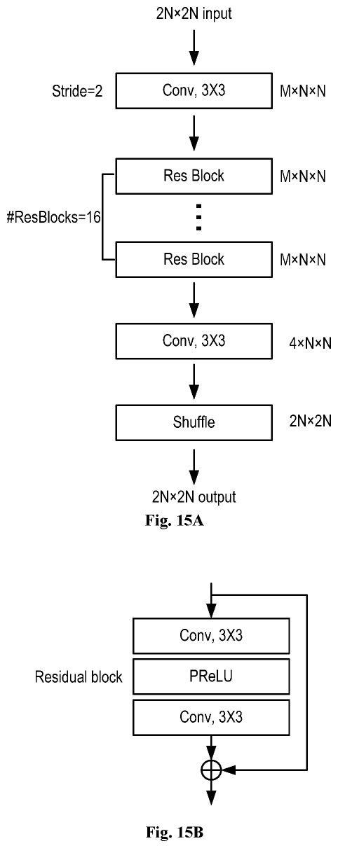

FIG. 14 shows an example of relative coordinates used for 5×5 diamond filter support supposing the current sample's coordinate (i, j) to be (0, 0). Samples in different coordinates filled with the same shading are multiplied with the same filter coefficients.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) \cdot I ( x + i , y + j ) , \qquad ( 11 )$$

where samples I(×+i, y+j) are input samples, O(x, y) is the filtered output sample (i.e. filter result), and w(i, j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) >> 7 , \qquad ( 12 )$$

where L denotes the filter length, and where w(i, j) are the filter coefficients in fixed point precision.
The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, in a traditional solution, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (111) can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) ) , \qquad ( 13 )$$

where w(i, j) are the same filter coefficients as in equation (11) [excepted w(0, 0) which is equal to 1 in equation (13) while it is equal to 1−Σ_{(i,j)≠(0,0)}w(i,j) in equation (11)].
Using this above filter formula of (13), VVC introduces the non-linearity to make ALF more efficient by using a simple clipping function to reduce the impact of neighbor sample values (I(x+i, y+j)) when they are too different with the current sample value (I(x, y)) being filtered.
More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) ) , \qquad ( 14 )$$

where K(d, b)=min(b, max(−b,d)) is the clipping function, and k(i, j) are clipping parameters, which depends on the (i, j) filter coefficient. The encoder performs the optimization to find the best k(i, j).
In a traditional solution, the clipping parameters k(i, j) are specified for each ALF filter, one clipping value is signaled per filter coefficient. It means that up to 12 clipping values can be signalled in the bitstream per Luma filter and up to 6 clipping values for the Chroma filter.
In order to limit the signaling cost and the encoder complexity, only 4 fixed values which are the same for INTER and INTRA slices are used.
Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.
The sets of clipping values used in the tests of the traditional solution are provided in the Table 5. The 4 values have been selected by roughly equally splitting, in the logarithmic domain, the full range of the sample values (coded on 10 bits) for Luma, and the range from 4 to 1024 for Chroma.
More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} , with M = {2}^{10} and N = 4. \qquad ( 15 )$$

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 … N ] \} , with M = {2}^{10} , N = 4 and A = 4. \qquad ( 16 )$$

TABLE 5
Authorized clipping values

| | INTRA/INTER tile group |
|---|---|
| LUMA | { 1024, 181, 32, 6 } |
| CHROMA | { 1024, 161, 25, 4 } |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Convolutional Neural Network-Based Loop Filters for Video Coding

### 2.9.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.
CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.
CNNs use relatively little pre-processing compared to other image classification/processing algorithms. This means that the network learns the filters that in traditional algorithms were hand-engineered. This independence from prior knowledge and human effort in feature design is a major advantage.

### 2.9.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks. For example, a solution proposes a fully connected network for the intra prediction in HEVC. In addition to intra prediction, deep learning is also exploited to enhance other modules. For example, another solution replaces the in-loop filters of HEVC with a convolutional neural network and achieves promising results. A further solution applies neural networks to improve the arithmetic coding engine.

### 2.9.3. Convolutional Neural Network Based In-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.9.3.1. Training

The purpose of the training processing is to find the optimal value of parameters including weights and bias.
First, a codec (e.g. HM, JEM, VTM, etc.) is used to compress the training dataset to generate the distorted reconstruction frames.
Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.9.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.
FIG. 15A shows an example architecture of the proposed convolutional neural network (CNN) filter where M denotes the number of feature maps and N stands for the number of samples in one dimension. FIG. 15B illustrates an example of the construction of residual block (ResBlock) in the CNN filter of FIG. 15A.
In most of deep convolutional neural networks, residual blocks are utilized as the basic module and stacked several times to construct the final network wherein in one example, the residual block is obtained by combining a convolutional layer, a ReLU/PRELU activation function and a convolutional layer as shown in FIG. 15B.

### 2.9.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. Problems

The current NN-based in-loop filtering has the following problems:
1. The network does not make fully use of information from previously coded frames to filter current frame. For example, temporal prediction has been used as additional input. However, there are other valuable information that can be potentially exploited, such as forward collocated reference block and backward collocated reference block.
2. When the information from multiple previously coded frames is exploited, the mechanism to use them is not efficient enough. For example, when large motion occurs between current frame and previously coded frames, it might reduce the filtering performance if simply taking a collocated block from a previously coded frame as an additional input.

### 4. Embodiments

The embodiments below should be considered as examples to explain general concepts. These embodiments should not be interpreted in a narrow way. Furthermore, these embodiments can be combined in any manner.
One or more neural network (NN) filter models are trained as part of an in-loop filtering technology or filtering technology used in a post-processing stage for reducing the distortion incurred during compression. Samples with different characteristics are processed by different NN filter models. The NN filter models might take information from one/multiple previously coded frames as additional input. The embodiments elaborate how to use information from previously coded frames, which information to use from previously coded frames, and when to use information from previously coded frames.
In the disclosure, a NN filter can be any kind of NN filter, such as a convolutional neural network (CNN) filter. In the following discussion, a NN filter may also be referred to as a non-CNN filter, e.g., filter using machine learning based solutions.
In the following discussion, a block may be a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick, an inference block. In some cases, the block could be one or multiple samples/pixels.
In the following discussion, a NN filter comprises a model/structure (i.e. network topology) and parameters associated with the model/structure.
In the following discussion, besides the additional information from reference frames, the NN filter models may take other information as input to filter the current block as well. For example, those other information could be the prediction information of current block, partitioning information of current block, boundary strengths information of current block, coding modes information of current block, etc.

### On the Multiple Reference Frames-Based Filtering

1. NN filter may take information from one/multiple previously coded frames as additional inputs when filtering a block in the current slice/frame.
   a. In one example, the previously coded frame may be a reference frame in a reference picture list (RPL) or reference picture set (RPS) associated with the block/the current slice/frame.
      i. In one example, the previously coded frame may be a short-term reference picture of the block/the current slice/frame.
      ii. In one example, the previously coded frame may be long-term reference picture of the block/the current slice/frame.
   b. Alternatively, the previously coded frame may NOT be a reference frame, but it is stored in the decoded picture buffer (DPB).
   c. In one example, at least one indicator is signalled to indicate which previously coded frame(s) to use.
      i. In one example, one indicator is signalled to indicate which reference picture list to use.
      ii. Alternatively, the indicator may be conditionally signalled, e.g., depending on how many reference pictures are included in the RPL/RPS.
      iii. Alternatively, the indicator may be conditionally signalled, e.g., depending on how many previously decoded pictures are included in the DPB.
   d. In one example, which frames to be utilized is determined on-the-fly.
      i. In one example, NN filter may take information from one/multiple previously coded frames in DPB as additional input.
      ii. In one example, NN filter may take information from one/multiple reference frames in list 0 as additional input.
      iii. In one example, NN filter may take information from one/multiple reference frames in list 1 as addition input.
      iv. In one example, NN filter may take information from reference frames in both list 0 and list 1 as additional input.
      v. In one example, NN filter may take information from the reference frame closest (e.g., with smallest POC distance to current slice/frame) to the current frame as additional input.
      vi. In one example, NN filter may take information from the reference frame with reference index equal to K (e.g., K=0) in a reference list.
         1) In one example, K may be pre-defined.
         2) In one example, K may be derived on-the-fly according to reference picture information.
      vii. In one example, NN filter may take information from the collocated frame as additional input.
      viii. In one example, which frame to be utilized may be determined by the decoded information.
         1) In one example, which frame to be utilized may be defined as the top N (e.g., N=1) most-frequently used reference pictures for samples within the current slice/frame.
         2) In one example, which frame to be utilized may be defined as the top N (e.g., N=1) most-frequently used reference pictures of each reference picture list, if available, for samples within the current slice/frame.
         3) In one example, which frame to be utilized may be defined as the pictures with top N (e.g., N=1) smallest POC distances/absolute POC distances relative to current picture.
   e. In one example, whether to take information from previously coded frames as additional input may be dependent on decoded information (e.g., coding modes/statistics/characteristics) of at least one region of the to-be-filtered block.
      i. In one example, whether to take information from previously coded frames as additional input may be dependent on the slice/picture type.
         1) In one example, it may be only applicable to inter-coded slices/pictures (e.g., P or B slices/pictures).
         2) In one example, whether to take information from previously coded frames as additional input may be dependent on availability of reference pictures.
      ii. In one example, whether to take information from previously coded frames as additional input may be dependent on the reference picture information or the picture information in the DPB.
         1) In one example, if the smallest POC distance (e.g., smallest POC distance between reference pictures/pictures in DPB and current picture) is greater than a threshold, it is disabled.
      iii. In one example, whether to take information from previously coded frames as additional input may be dependent on the temporal layer index.
         1) In one example, it may be applicable to blocks with a given temporal layer index (e.g., the highest temporal layer).
      iv. In one example, if the to-be-filtered block contains a portion of samples that are coded in non-inter mode, NN filter will not use information from previously coded frames to filter the block.
         1) In one example, the non-inter mode may be defined as intra mode.
         2) In one example, the non-inter mode may be defined as a set of coding mode which includes intra/IBC/Palette modes.
      v. In one example, a distortion between current block and the matching block is calculated and used to decide whether to take information from previously coded frames as additional input to filter current block.
         1) Alternatively, the distortion between the collocated block in a previously coded frame and current block can be used to decide whether to take information from previously coded frames as additional input to filter current block.
         2) In one example, motion estimation is first used to find a matching block from at least one previously coded frame.
         3) In one example, when the distortion is larger than a pre-defined threshold, information from previously coded frames will not be used.
            On the Information from Previously Coded Frames
2. To help filter current block, NN filter model may use additional information from previously coded frames. The information may contain reconstruction samples/motion information in the previously coded frames.
   a. In one example, reconstruction samples may be defined as those in the one/multiple reference blocks and/or collocated blocks of current block.
   b. In one example, reconstruction samples may be defined as those in a region pointed by a motion vector.
      i. In one example, the motion vector may be different from the decoded motion vector associated with current block.
   c. In one example, a collocated block may refer to a block whose center is located at the same horizontal and vertical position in a previously coded frame as that of current block in the current frame.
   d. In one example, a reference block is derived by motion estimation, i.e. searching from a previously coded frame to find the block that is closest to current block with a certain measure.
      i. In one example, the motion estimation is performed at integer precision to avoid fractional pixel interpolation.
   e. In one example, a reference block is derived by reusing at least one motion vector contained in the current block.
      i. In one example, the motion vector is first rounded to the integer precision to avoid fractional pixel interpolation.
      ii. In one example, the reference block is located by adding an offset which is determined by the motion vector to the position of the current block.
      iii. In one example, the motion vector should refer to the previously coded picture containing the reference block.
      iv. In one example, the motion vector may be scaled to the previously coded picture containing the reference block.
   f. In one example, reference blocks and/or collocated blocks are the same size of current block.
   g. In one example, reference blocks and/or collocated blocks could be larger than current block.
      i. In one example, reference blocks and/or collocated blocks with the same size of current block are first found and then extended at each boundary to contain more samples from previously coded samples.
         1) In one example, the size of extended area could be signalled to the decoder or derived on-the-fly.
   h. In one example, the information contains two reference blocks and/or collocated blocks of current block, with one of them from the first reference frame in list-0 and the other from the first reference frame in list-1.
      On how to Feed the Information from Previously Coded Frames into NN Filter Models
3. To help filter the current block, additional information from previously coded frames is fed as input of NN filter models. The additional information such as reference blocks, collocated blocks, etc. may be fed together or separately with other information such as prediction, partitioning information, etc.
   a. In one example, different kinds of information should be organized with the same size (such as the width and/or height of the 2D data) and thus are concatenated together to be fed into the NN filter models.
   b. In one example, a separate convolutional branch may first extract features from the additional information such as one/multiple reference blocks and/or collocated blocks of current block in the previously coded frames. Those extracted features may be then fused together with other input information or fused together with the features extracted from other input information.
      i. In one example, the reference blocks and/or collocated blocks of current block in the previously coded frames may be with different size to (e.g. larger than) other input information such as prediction, partitioning etc.
         1) In one example, a separate convolutional branch is used to extract features that have the same spatial dimension as other input information.
   c. In one example, current block together with the reference blocks and/or collocated blocks are fed together into a motion alignment branch. The output of the motion alignment branch is then fused together other information.

### On Other NN-Based Tools

4. The above methods may be applied to other coding technologies using NNs, e.g., super-resolution, inter prediction, virtual reference frame generation, etc.
   a. In one example, a NN model is used to super-resolve a block in a inter slice. The NN model may take information from one/multiple previously coded frames as additional input.
5. Whether to/how to apply the proposed method may be signaled from the encoder to the decoder such as in SPS/PPS/APS/slice header/picture header/CTU/CU, etc.
6. Whether to/how to apply the proposed method may depend on coding information such as color component, QP, temporal layer etc.
   a. For example, the proposed method may only be applied on a luma component, but not on a chroma component.
   b. For example, the proposed method may be applied on a luma component and also on a chroma component.

The embodiments of the present disclosure are related to use of previously coded frames by a machine learning model when filtering a current video block. The embodiments can be applied to a variety of coding technologies, including but not limited to, compression, super-resolution, inter prediction, virtual reference frame generation, etc.

As used herein, the term “block” may represent a slice, a tile, a brick, a subpicture, a coding tree unit (CTU), a coding tree block (CTB), a CTU row, a CTB row, one or multiple coding units (CUs), one or multiple coding blocks (CBs), one ore multiple CTUs, one ore multiple CTBs, one or multiple Virtual Pipeline Data Units (VPDUs), a sub-region within a picture/slice/tile/brick, an inference block. In some embodiments, the block may represent one or multiple samples, or one or multiple pixels.

As used herein, a frame containing the current video block is referred to as a “current frame” or a “current picture”. A slice containing the current video block is referred to as a “current slice” or a “current slice”. The terms “frame” and “picture” can be used interchangeably. The terms “sample” and “pixel” can be used interchangeably.

As used herein, the term “machine learning model” may represent a filter based on a machine learning model. The machine learning model or the filter based on the machine learning model comprises a structure and parameters associated with the structure. In some embodiments, the machine learning model may comprise a neural network (NN) and the filter based on the machine learning model is a NN filter or a NN filter model.

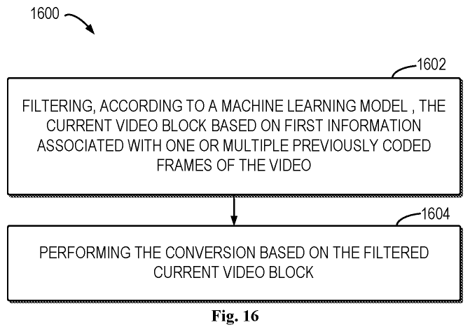

FIG. 16 illustrates a flowchart of a method 1600 for video processing in accordance with some embodiments of the present disclosure. The method 1600 may be implemented during a conversion between a current video block of a video and a bitstream of the video. As shown in FIG. 16, at block 1602, the current video block is filtered according to a machine learning model and based on first information associated with one or multiple previously coded frames of the video.

At block 1604, the conversion is performed based on the filtered current video block. In some embodiments, the conversion may include encoding the current video block into the bitstream. Alternatively, or in addition, the conversion may include decoding the current video block from the bitstream.

The method 1600 enables the utilization of information from previously coded frames by a machine learning model when filter a current block. Compared with the conventional solution where only previously coded frame is not utilized by a machine learning model, coding performance can be improved. For example, distortion during compression can be reduced.

In some embodiments, the one or multiple previously coded frames may comprise a reference frame in at least one of: a reference picture list (RPL) associated with the current video block, a RPL associated with a current slice comprising the current video block, a RPL associated with a current frame comprising the current video block, a reference picture set (RPS) associated with the current video block, a RPS associated with the current slice, or a RPS associated with the current frame.

In some embodiments, the one or multiple previously coded frames may comprise a short-term reference frame of the current video block. Alternatively, or in addition, in some embodiments, the one or multiple previously coded frames may comprise a short-term reference frame of the current slice. Alternatively, or in addition, in some embodiments, the one or multiple previously coded frames may comprise a short-term reference frame of the current frame.

In some embodiments, the one or multiple previously coded frames may comprise a long-term reference frame of the current video block. Alternatively, or in addition, in some embodiments, the one or multiple previously coded frames may comprise a long-term reference frame of the current slice. Alternatively, or in addition, in some embodiments, the one or multiple previously coded frames may comprise a long-term reference frame of the current frame.

Alternatively, in some embodiments, the one or multiple previously coded frames may comprise a frame stored in a decoded picture buffer (DPB) that is not a reference frame. For example, the previously coded frame used by the machine learning model is not a reference frame, but it is stored in the DPB.

In some embodiments, at least one indicator may be indicated in the bitstream to indicate the one or multiple previously coded frames. For example, the at least one indicator may be signalled to indicate which previously coded frame(s) to use.

In some embodiments, the at least one indicator may comprise an indicator to indicate a reference picture list comprising the one or multiple previously coded frames. For example, an indicator may be signalled to indicate which reference picture list to use.

In some embodiments, the at least one indicator may be indicated in the bitstream based on a condition. For example, the at least one indicator may be conditionally signalled.

In some embodiments, the condition may comprise at least one of the number of reference pictures included in a RPL associated with the current video block, the number of reference pictures included in a RPL associated with a current slice comprising the current video block, the number of reference pictures included in a RPL associated with a current frame comprising the current video block, the number of reference pictures included in a RPS associated with the current video block, the number of reference pictures included in a RPS associated with the current slice, or the number of reference pictures included in a RPS associated with the current frame. For example, the at least one indicator may be conditionally signalled depending on how many reference pictures are included in the RPL/RPS.

Alternatively, or in addition, in some embodiments, the condition may comprise the number of decoded pictures included on a DPB. For example, the at least one indicator may conditionally signalled depending on how many previously decoded pictures are included in the DPB.

In some embodiments, the method 1600 may further comprise determining the one or multiple previously coded frames for the current video block. In other words, which previously coded frames to be utilized may be determined on-the-fly.

In some embodiments, the one or multiple previously coded frames to be used may be determined from at least one previously coded frame in a DPB. For example, the machine learning model filter may take information from one/multiple previously coded frames in DPB as additional input.

In some embodiments, the one or multiple previously coded frames to be used may be determined from at least one reference frame in list 0. For example, the machine learning model filter may take information from one/multiple reference frames in list 0 as additional input.

In some embodiments, the one or multiple previously coded frames to be used may be determined from at least one reference frame in list 1. For example, the machine learning model filter may take information from one/multiple reference frames in list 1 as additional input.

In some embodiments, the one or multiple previously coded frames to be used may be determined from reference frames in both list 0 and list 1. For example, the machine learning model filter may take information from one/multiple reference frames in both list 0 and list 1 as additional input.

In some embodiments, the one or multiple previously coded frames to be used may be determined from a reference frame closest to a current frame comprising the current video block. For example, the machine learning model filter may take information from the reference frame closest to the current frame as additional input. The reference frame closet to the current frame may be a frame with the smallest POC distance to the current slice or the current frame.

In some embodiments, the one or multiple previously coded frames to be used may be determined from a reference frame with a reference index equal to K in a reference list. In an example, K=0.

In some embodiments, the value of K may be predefined. Alternatively, in some embodiments, the value of K may be determined based on reference picture information. In other words, K may be derived on-the-fly according to reference picture information.

In some embodiments, the one or multiple previously coded frames to be used may be determined from a collocated frame. The machine learning model filter may take information from the collocated frame as additional input.

In some embodiments, the one or multiple previously coded frames to be used may be determined based on decoded information. In other words, which previously coded frame to be utilized may be determined by the decoded information.

In some embodiments, the one or multiple previously coded frames to be used may be determined or defined as the top N most-frequently used reference frames for samples within a current slice comprising the current video block, and/or a current frame comprising the current video block. N is a positive integer. In an example, N=1.

In some embodiments, the one or multiple previously coded frames to be used may be determined or defined as the top N most-frequently used reference frames of each reference picture list for samples within the current slice and/or the current frame. N is a positive integer. In an example, N=1.

In some embodiments, the one or multiple previously coded frames to be used may be determined or defined as frames with top N smallest picture order count (POC) distances or absolute POC distances relative to a current frame comprising the current video block. N is a positive integer. In an example, N=1.

In some embodiments, whether the first information is used to filter the current video block may depend on decoded information of at least one region of the current video block. As used herein, whether the first information is used to filter the current video block means whether to take information from the one or more previously coded frame as additional input to the machine learning model. The decoded information may include coding modes, statistics, characteristics, for example.

In some embodiments, whether the first information is used to filter the current video block may depends on a type of the current slice. Alternatively, or in addition, whether the first information is used to filter the current video block may depends on a type of the current frame.

In some embodiments, the first information is used to filter the current video block if at least one of the following is met: the type of the current slice indicates an inter-coded slice, or the type of the current frame indicates an inter-coded frame. In other words, the first information may be applicable to a block in the inter-coded slices or inter-coded pictures, e.g., P or B slices, P or B pictures.

In some embodiments, whether the first information is used to filter the current video block may depend on an availability of reference frames for the current video block. For example, if the current video block does not have a reference frame, no first information is fed to the machine learning model.

In some embodiments, whether the first information is used to filter the current video block may depend on reference picture information. Alternatively, or in addition, in some embodiments, whether the first information is used to filter the current video block may depend on picture information in a DPB.

In some embodiments, the first information is used to filter the current video block if a smallest POC distance associated with the current video block is not greater than a threshold. In such embodiments, if the smallest POC distance (e.g., smallest POC distance between reference pictures/pictures in DPB and current picture) is greater than a threshold, use of the first information disabled. In an example, the smallest POC distance associated with the current video block may be the smallest POC distance between reference pictures and the current frame or the smallest POC distance between pictures in DPB and the current frame.

In some embodiments, whether the first information is used to filter the current video block depends on a temporal layer index associated with the current video block. In other words, whether to take information from previously coded frames as additional input may be dependent on the temporal layer index.

In some embodiments, the first information is used to filter the current video block if the current video block has a given temporal layer index. As an example, the given temporal layer index may be the highest temporal layer. In other words, the information from the previously coded frames may be applicable to blocks with a given temporal layer index (e.g., the highest temporal layer).

In some embodiments, the first information is used to filter the current video block if the current video block does not comprise a sample coded in a non-inter mode. In other words, if the current video block contains a portion of samples that are coded in non-inter mode, the machine learning model will not use information from previously coded frames to filter the block.

In some embodiments, the non-inter mode may comprise or be defined as an intra mode.

In some embodiments, the non-inter mode may comprise at least one of a set of coding modes consisting of: an intra mode, an intra block copy (IBC) mode, or a Palette mode. For example, the non-inter mode may be defined as a set of coding mode which includes intra mode, IBC mode and Palette mode.

In some embodiments, whether the first information is used to filter the current video block may depend a distortion between the current video block and a matching block for the current video block. For example, a distortion between the current video block and the matching block is calculated and used to decide whether to take information from previously coded frames as additional input to filter the current video block. In some embodiments, motion estimation may be performed to determine the matching block from at least one previously coded frame of the video. For example, the motion estimation is first used to find a matching block from at least one previously coded frame and then the distortion is calculated.

Alternatively, or in addition, in some embodiments, a distortion between the current video block and a collocated block in a previously coded frame of the video. For example, a distortion between the current video block and the collocated block is calculated and used to decide whether to take information from previously coded frames as additional input to filter the current video block.

In some embodiments, the first information is used to filter the current video block if the distortion is not larger than a threshold. In other words, when the distortion is larger than a pre-defined threshold, information from previously coded frames will not be used.

In some embodiments, the first information may comprise reconstruction samples in the one or multiple previously coded frames. Alternatively, or in addition, in some embodiments, the first information may comprise motion information associated with the one or multiple previously coded frames.

In some embodiments, the reconstruction samples may comprise at least one of: samples in at least one reference block for the current video block, or samples in at least one collocated block for the current video block. For example, the reconstruction samples may be defined as those in the one or multiple reference blocks and/or the one or multiple collocated blocks of the current video block.

In some embodiments, the reconstruction samples may comprise samples in a region pointed by a motion vector. For example, the reconstruction samples can be defined as those in a region pointed by a motion vector. In some embodiments, the motion vector may be different from a decoded motion vector associated with the current video block.

In some embodiments, a center of a collocated block of the at least one collocated block is located at the same horizontal and vertical position in a previously coded frame as that of the current video block in a current frame. In other words, a collocated block may refer to a block whose center is located at the same horizontal and vertical position in a previously coded frame as that of the current video block in the current frame.

In some embodiments, the at least one reference block may be determined by motion estimation. For example, a reference block can be derived by motion estimation, i.e. searching from a previously coded frame to find the block that is closest to the current video block with a certain measure.

In some embodiments, the motion estimation may be performed at an integer precision. As such, fractional pixel interpolation can be avoided.

In some embodiments, a reference block of the at least one reference block is determined by reusing at least one motion vector included in the current video block. For example, a reference block can be derived by reusing at least one motion vector contained in the current video block.

In some embodiments, the at least one motion vector is rounded to an integer precision. As such, fractional pixel interpolation can be avoided.

In some embodiments, the reference block may be located by adding an offset to the position of the current video block, wherein the offset is determined by the at least one motion vector.

In some embodiments, the at least one motion vector may point to a previously coded frame comprising the reference block. For example, the motion vector may refer to the previously coded picture containing the reference block.

In some embodiments, the at least one motion vector may be scaled to a previously coded frame comprising the reference block.

In some embodiments, at least one block of the at least one reference block and/or the at least one collocated block may be the same size as the current video block. For example, the reference blocks and/or collocated blocks may be the same size of the current video block.

In some embodiments, at least one block of the at least one reference block and/or the at least one collocated block may be larger than the current video block. For example, the reference blocks and/or collocated blocks may be larger than the current video block.

In some embodiments, the at least one block with the same size as the current video block may be rounded and extended at at least one boundary to include more samples from a previously code frame. For example, reference blocks and/or collocated blocks with the same size as the current video block are first found and then extended at each boundary to contain more samples from previously coded samples.

In some embodiments, a size of the extended area may be indicated in the bitstream. Alternatively, in some embodiments, the size of the extended area may be derived during decoding the current video block from the bitstream. For example, the size of the extended area may be signalled to the decoder or derived on-the-fly by the decoder.

In some embodiments, the first information may comprise two reference blocks for the current video block with one of the two reference blocks from the first reference frame in list 0 and the other one from the first reference frame in list 1. Alternatively, or in addition, in some embodiments, the first information may comprise two collocated blocks for the current video block with one of the two collocated blocks from the first reference frame in list 0 and the other one from the first reference frame in list 1.

In some embodiments, the current video block may be filtered further based on second information different from the first information, and the first and second information is fed to the machine learning model together or separately. The second information may include prediction information of the current video block, partitioning information of the current video block, boundary strengths information of the current video block, coding modes information of the current video block, etc. The first information is fed as input to the machine learning model. The first information such as reference blocks, collocated blocks, etc. may be fed together or separately with the second information such as prediction information, partitioning information, etc.

In some embodiments, the first and second information may be organized to have the same size and concatenated together to be fed to the machine learning model. For example, these different kinds of information may be organized with the same size (such as the width and/or height of the 2D data) and thus are concatenated together to be fed into the machine learning model.

In some embodiments, features may be extracted from the first information through a separate convolutional branch of the machine learning model and the extracted features are combined with the second information or features extracted from the second information. For example, a separate convolutional branch of the machine learning model may first extract features from the first information such as one or multiple reference blocks and/or collocated blocks of the current video block in the previously coded frames. Those extracted features may be then fused together with the second information or fused together with the features extracted from the second information.

In some embodiments, the first information may comprise at least one reference block and/or at least one collocated block for the current video block in the one or multiple previously coded frames, and the at least one reference block and/or at least one collocated block may have a spatial dimension different from the second information. For example, the reference blocks and/or collocated blocks of the current video block may have a different size from (e.g. larger than) the second information such as the prediction information, partitioning information, etc.

In some embodiments, the machine learning model may have a separate convolutional branch for extracting, from the at least one reference block and/or at least one collocated block, features with the same spatial dimension as the second information. For example, a separate convolutional branch may be used to extract from the first information features that have the same spatial dimension as the second information.

In some embodiments, the current video block together with at least one reference block and/or at least one collocated block in the one or multiple previously coded frames may be fed to a motion alignment branch of the machine learning model. An output of the motion alignment branch may be combined with the second information.

In some embodiments, filtering the current video block may be used for at least one of: compression, super-resolution, inter prediction, or virtual reference frame generation. The above methods may be applied to compression or other coding technologies using machine learning, e.g., super-resolution, inter prediction, virtual reference frame generation, etc.

In some embodiments, the current video block may be super-resolved by using the machine learning model. For example, the machine learning model (e.g., a NN model) is used to super-resolve a block in a inter slice. The machine learning model may take information from one or multiple previously coded frames as additional input.

In some embodiments, usage of the first information by the machine learning model may be indicated in the bitstream. In some embodiments, the usage of the first information by the machine learning model may be indicated in at least one of: sequence parameter set (SPS), picture parameter set (SPS), adaptation parameter set (APS), slice header, picture header, CTU, or CU. For example, whether to use the first information and/or how to use the first information may be signaled from the encoder to the decoder such as in SPS/PPS/APS/slice header/picture header/CTU/CU, etc.

In some embodiments, usage of the first information by the machine learning model depends on coding information. The coding information may include color component, quantization parameter (QP), temporal layer etc.

In some embodiments, the first information may be applied to a luma component of the current video block by the machine learning model without be applied to a chroma component. In other words, the proposed method may only be applied on a luma component, but not on a chroma component.

In some embodiments, the first information may be applied to both a luma component and a chroma component of the current video block by the machine learning model. In other words, the proposed method may be applied on a luma component and also on a chroma component.

In some embodiments, the machine learning model may comprise a neural network.

In some embodiments, a bitstream of a video may be stored in a non-transitory computer-readable recording medium. The bitstream of the video can be generated by a method performed by a video processing apparatus. According to the method, a current video block of the video may be filtered according to a machine learning model and based on first information associated with one or multiple previously coded frames of the video. The bitstream may be generated based on the filtered current video block.

In some embodiments, a current video block of a video may be filtered according to a machine learning model and based on first information associated with one or multiple previously coded frames of the video. A bitstream may be generated based on the filtered current video block. The bitstream may be stored in a non-transitory computer-readable recording medium.

Implementations of the present disclosure can be described in view of the following clauses, the features of which can be combined in any reasonable manner.

Clause 1. A method for video processing, comprising: filtering, according to a machine learning model during a conversion between a current video block of a video and a bitstream of the video, the current video block based on first information associated with one or multiple previously coded frames of the video; and performing the conversion based on the filtered current video block.

Clause 2. The method of clause 1, wherein the one or multiple previously coded frames comprise a reference frame in at least one of: a reference picture list (RPL) associated with the current video block, a RPL associated with a current slice comprising the current video block, a RPL associated with a current frame comprising the current video block, a reference picture set (RPS) associated with the current video block, a RPS associated with the current slice, or a RPS associated with the current frame.

Clause 3. The method of clause 2, wherein the one or multiple previously coded frames comprise at least one of: a short-term reference frame of the current video block, a short-term reference frame of the current slice, or a short-term reference frame of the current frame.

Clause 4. The method of any of clauses 2-3, wherein the one or multiple previously coded frames comprise at least one of: a long-term reference frame of the current video block, a long-term reference frame of the current slice, or a long-term reference frame of the current frame.

Clause 5. The method of any of clauses 1-4, wherein the one or multiple previously coded frames comprise a frame stored in a decoded picture buffer (DPB) that is not a reference frame.

Clause 6. The method of any of clauses 1-5, wherein at least one indicator is indicated in the bitstream to indicate the one or multiple previously coded frames.

Clause 7. The method of clause 6, wherein the at least one indicator comprises an indicator to indicate a reference picture list comprising the one or multiple previously coded frames.

Clause 8. The method of any of clauses 6-7, wherein the at least one indicator is indicated in the bitstream based on a condition.

Clause 9. The method of clause 8, wherein the condition comprises at least one of: the number of reference pictures included in a RPL associated with the current video block, the number of reference pictures included in a RPL associated with a current slice comprising the current video block, the number of reference pictures included in a RPL associated with a current frame comprising the current video block, the number of reference pictures included in a RPS associated with the current video block, the number of reference pictures included in a RPS associated with the current slice, or the number of reference pictures included in a RPS associated with the current frame.

Clause 10. The method of clause 8, wherein the condition comprises the number of decoded pictures included on a DPB.

Clause 11. The method of any of clauses 1-10, further comprising: determining the one or multiple previously coded frames for the current video block.

Clause 12. The method of clause 11, wherein determining the one or multiple previously coded frames comprises: determining the one or multiple previously coded frames from at least one previously coded frame in a DPB.

Clause 13. The method of any of clauses 11-12, wherein determining the one or multiple previously coded frames comprises: determining the one or multiple previously coded frames from at least one reference frame in list 0.

Clause 14. The method of any of clauses 11-13, wherein determining the one or multiple previously coded frames comprises: determining the one or multiple previously coded frames from at least one reference frame in list 1.

Clause 15. The method of any of clauses 11-14, wherein determining the one or multiple previously coded frames comprises: determining the one or multiple previously coded frames from reference frames in both list 0 and list 1.

Clause 16. The method of any of clauses 11-15, wherein determining the one or multiple previously coded frames comprises: determining the one or multiple previously coded frames from a reference frame closest to a current frame comprising the current video block.

Clause 17. The method of any of clauses 11-16, wherein determining the one or multiple previously coded frames comprises: determining the one or multiple previously coded frames from a reference frame with a reference index equal to K in a reference list.

Clause 18. The method of clause 17, wherein the value of K is predefined.

Clause 19. The method of clause 17, wherein the value of K is determined based on reference picture information.

Clause 20. The method of any of clauses 11-19, wherein determining the one or multiple previously coded frames comprises: determining the one or multiple previously coded frames from a collocated frame.

Clause 21. The method of any of clauses 11-20, wherein determining the one or multiple previously coded frames comprises: determining the one or multiple previously coded frames based on decoded information.

Clause 22. The method of clause 21, wherein determining the one or multiple previously coded frames based on decoded information comprises: determining the one or multiple previously coded frames as the top N most-frequently used reference frames for samples within at least one of: a current slice comprising the current video block, or a current frame comprising the current video block, wherein N is a positive integer.

Clause 23. The method of clause 21, wherein determining the one or multiple previously coded frames based on decoded information comprises: determining the one or multiple previously coded frames as the top N most-frequently used reference frames of each reference picture list for samples within at least one of: a current slice comprising the current video block, or a current frame comprising the current video block, wherein N is a positive integer.

Clause 24. The method of clause 21, wherein determining the one or multiple previously coded frames based on decoded information comprises: determining the one or multiple previously coded frames as frames with top N smallest picture order count (POC) distances or absolute POC distances relative to a current frame comprising the current video block, wherein N is a positive integer.

Clause 25. The method of any of clauses 1-24, wherein whether the first information is used to filter the current video block depends on decoded information of at least one region of the current video block.

Clause 26. The method of clause 25, wherein whether the first information is used to filter the current video block depends on at least one of: a type of a current slice comprising the current video block, or a type of a current frame comprising the current video block.

Clause 27. The method of clause 26, wherein the first information is used to filter the current video block if at least one of the following is met: the type of the current slice indicates an inter-coded slice, or the type of the current frame indicates an inter-coded frame.

Clause 28. The method of clause 25, wherein whether the first information is used to filter the current video block depends on an availability of reference frames for the current video block.

Clause 29. The method of clause 25, wherein whether the first information is used to filter the current video block depends on at least one of: reference picture information, or picture information in a DPB.

Clause 30. The method of clause 29, wherein the first information is used to filter the current video block if a smallest POC distance associated with the current video block is not greater than a threshold.

Clause 31. The method of clause 25, wherein whether the first information is used to filter the current video block depends on a temporal layer index associated with the current video block.

Clause 32. The method of clause 31, wherein the first information is used to filter the current video block if the current video block has a given temporal layer index.

Clause 33. The method of clause 25, wherein the first information is used to filter the current video block if the current video block does not comprise a sample coded in a non-inter mode.

Clause 34. The method of clause 33, wherein the non-inter mode comprises an intra mode.

Clause 35. The method of clause 33, wherein the non-inter mode comprises at least one of a set of coding modes consisting of: an intra mode, an intra block copy (IBC) mode, or a Palette mode.

Clause 36. The method of clause 25, wherein whether the first information is used to filter the current video block depends on at least one of: a distortion between the current video block and a matching block for the current video block, or a distortion between the current video block and a collocated block in a previously coded frame of the video.

Clause 37. The method of clause 36, further comprising: performing motion estimation to determine the matching block from at least one previously coded frame of the video.

Clause 38. The method of clause 37, wherein the first information is used to filter the current video block if the distortion is not larger than a threshold.

Clause 39. The method of any of clauses 1-38, wherein the first information comprises at least one of: reconstruction samples in the one or multiple previously coded frames, or motion information associated with the one or multiple previously coded frames.

Clause 40. The method of clause 39, wherein the reconstruction samples comprise at least one of: samples in at least one reference block for the current video block, or samples in at least one collocated block for the current video block.

Clause 41. The method of clause 39, wherein the reconstruction samples comprise samples in a region pointed by a motion vector.

Clause 42. The method of clause 41, wherein the motion vector is different from a decoded motion vector associated with the current video block.

Clause 43. The method of clause 40, wherein a center of a collocated block of the at least one collocated block is located at the same horizontal and vertical position in a previously coded frame as that of the current video block in a current frame.

Clause 44. The method of clause 40, wherein the at least one reference block is determined by motion estimation.

Clause 45. The method of clause 44, wherein the motion estimation is performed at an integer precision.

Clause 46. The method of clause 40, wherein a reference block of the at least one reference block is determined by reusing at least one motion vector included in the current video block.

Clause 47. The method of clause 46, wherein the at least one motion vector is rounded to an integer precision.

Clause 48. The method of any of clauses 46-47, wherein the reference block is located by adding an offset to the position of the current video block, wherein the offset is determined by the at least one motion vector.

Clause 49. The method of any of clauses 46-48, wherein the at least one motion vector points to a previously coded frame comprising the reference block.

Clause 50. The method of any of clauses 46-49, wherein the at least one motion vector is scaled to a previously coded frame comprising the reference block.

Clause 51. The method of clause 40, wherein at least one block of the at least one reference block and/or the at least one collocated block is the same size as the current video block.

Clause 52. The method of clause 40, wherein at least one block of the at least one reference block and/or the at least one collocated block is larger than the current video block.

Clause 53. The method of clause 52, wherein the at least one block with the same size as the current video block is rounded and extended at at least one boundary to include more samples from a previously code frame.

Clause 54. The method of clause 53, wherein a size of the extended area is indicated in the bitstream or is derived during decoding the current video block from the bitstream.

Clause 55. The method of any of clauses 1-54, wherein the first information comprises at least one of: two reference blocks for the current video block with one of the two reference blocks from the first reference frame in list 0 and the other one from the first reference frame in list 1, or two collocated blocks for the current video block with one of the two collocated blocks from the first reference frame in list 0 and the other one from the first reference frame in list 1.

Clause 56. The method of any of clauses 1-55, wherein the current video block is filtered further based on second information different from the first information, and the first and second information is fed to the machine learning model together or separately.

Clause 57. The method of clause 56, wherein the first and second information is organized to have the same size and concatenated together to be fed to the machine learning model.

Clause 58. The method of clause 56, wherein features are extracted from the first information through a separate convolutional branch of the machine learning model and the extracted features are combined with the second information or features extracted from the second information.

Clause 59. The method of clause 58, wherein the first information comprises at least one reference block and/or at least one collocated block for the current video block in the one or multiple previously coded frames, and the at least one reference block and/or at least one collocated block have a spatial dimension different from the second information.

Clause 60. The method of clause 59, wherein the machine learning model has a separate convolutional branch for extracting, from the at least one reference block and/or at least one collocated block, features with the same spatial dimension as the second information.

Clause 61. The method of clause 56, wherein the current video block together with at least one reference block and/or at least one collocated block in the one or multiple previously coded frames are fed to a motion alignment branch of the machine learning model and an output of the motion alignment branch is combined with the second information.

Clause 62. The method of any of clauses 1-61, wherein filtering the current video block is used for at least one of: compression, super-resolution, inter prediction, or virtual reference frame generation.

Clause 63. The method of clause 63, wherein the current video block is super-resolved by using the machine learning model.

Clause 64. The method of any of clauses 1-63, wherein usage of the first information by the machine learning model is indicated in the bitstream.

Clause 65. The method of clause 64, wherein usage of the first information by the machine learning model is indicated in at least one of: sequence parameter set (SPS), picture parameter set (SPS), adaptation parameter set (APS), slice header, picture header, coding tree unit (CTU), or coding unit (CU).

Clause 66. The method of any of clauses 1-65, wherein usage of the first information by the machine learning model depends on coding information.

Clause 67. The method of clause 66, wherein the first information is applied to a luma component of the current video block by the machine learning model without be applied to a chroma component.

Clause 68. The method of clause 66, wherein the first information is applied to both a luma component and a chroma component of the current video block by the machine learning model.

Clause 69. The method of any of clauses 1-68, wherein the machine learning model comprises a neural network.

Clause 70. The method of any of clauses 1-69, wherein the conversion includes encoding the target video block into the bitstream.

Clause 71. The method of any of clauses 1-69, wherein the conversion includes decoding the target video block from the bitstream.

Clause 72. An apparatus for processing video data comprising a processor and a non-transitory memory with instructions thereon, wherein the instructions upon execution by the processor, cause the processor to perform a method in accordance with any of Clauses 1-71.

Clause 73. A non-transitory computer-readable storage medium storing instructions that cause a processor to perform a method in accordance with any of Clauses 1-71.

Clause 74. A non-transitory computer-readable recording medium storing a bitstream of a video which is generated by a method performed by a video processing apparatus, wherein the method comprises filtering, according to a machine learning model, a current video block of the video based on first information associated with one or multiple previously coded frames of the video; and generating the bitstream based on the filtered current video block.

Clause 75. A method for storing a bitstream of a video, comprising: filtering, according to a machine learning model, a current video block of the video based on first information associated with one or multiple previously coded frames of the video; generating the bitstream based on the filtered current video block; and storing the bitstream in a non-transitory computer-readable recording medium.

### Example Device

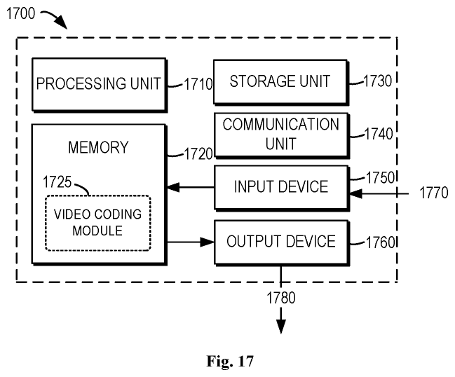

FIG. 17 illustrates a block diagram of a computing device 1700 in which various embodiments of the present disclosure can be implemented. The computing device 1700 may be implemented as or included in the source device 110 (or the video encoder 114 or 200) or the destination device 120 (or the video decoder 124 or 300).

It would be appreciated that the computing device 1700 shown in FIG. 17 is merely for purpose of illustration, without suggesting any limitation to the functions and scopes of the embodiments of the present disclosure in any manner.

As shown in FIG. 17, the computing device 1700 includes a general-purpose computing device 1700. The computing device 1700 may at least comprise one or more processors or processing units 1710, a memory 1720, a storage unit 1730, one or more communication units 1740, one or more input devices 1750, and one or more output devices 1760.

In some embodiments, the computing device 1700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1700 can support any type of interface to a user (such as “wearable” circuitry and the like).

The processing unit 1710 may be a physical or virtual processor and can implement various processes based on programs stored in the memory 1720. In a multi-processor system, multiple processing units execute computer executable instructions in parallel so as to improve the parallel processing capability of the computing device 1700. The processing unit 1710 may also be referred to as a central processing unit (CPU), a microprocessor, a controller or a microcontroller.

The computing device 1700 typically includes various computer storage medium. Such medium can be any medium accessible by the computing device 1700, including, but not limited to, volatile and non-volatile medium, or detachable and non-detachable medium. The memory 1720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1730 may be any detachable or non-detachable medium and may include a machine-readable medium such as a memory, flash memory drive, magnetic disk or another other media, which can be used for storing information and/or data and can be accessed in the computing device 1700.

The computing device 1700 may further include additional detachable/non-detachable, volatile/non-volatile memory medium. Although not shown in FIG. 17, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1740 communicates with a further computing device via the communication medium. In addition, the functions of the components in the computing device 1700 can be implemented by a single computing cluster or multiple computing machines that can communicate via communication connections. Therefore, the computing device 1700 can operate in a networked environment using a logical connection with one or more other servers, networked personal computers (PCs) or further general network nodes.

The input device 1750 may be one or more of a variety of input devices, such as a mouse, keyboard, tracking ball, voice-input device, and the like. The output device 1760 may be one or more of a variety of output devices, such as a display, loudspeaker, printer, and the like. By means of the communication unit 1740, the computing device 1700 can further communicate with one or more external devices (not shown) such as the storage devices and display device, with one or more devices enabling the user to interact with the computing device 1700, or any devices (such as a network card, a modem and the like) enabling the computing device 1700 to communicate with one or more other computing devices, if required. Such communication can be performed via input/output (I/O) interfaces (not shown).

In some embodiments, instead of being integrated in a single device, some or all components of the computing device 1700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1700 may be used to implement video encoding/decoding in embodiments of the present disclosure. The memory 1720 may include one or more video coding modules 1725 having one or more program instructions. These modules are accessible and executable by the processing unit 1710 to perform the functionalities of the various embodiments described herein.

In the example embodiments of performing video encoding, the input device 1750 may receive video data as an input 1770 to be encoded. The video data may be processed, for example, by the video coding module 1725, to generate an encoded bitstream. The encoded bitstream may be provided via the output device 1760 as an output 1780.

In the example embodiments of performing video decoding, the input device 1750 may receive an encoded bitstream as the input 1770. The encoded bitstream may be processed, for example, by the video coding module 1725, to generate decoded video data. The decoded video data may be provided via the output device 1760 as the output 1780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
filtering, according to a machine learning model during a conversion between a current video block of a video and a bitstream of the video, the current video block based on first information associated with one or multiple previously coded frames of the video; and
performing the conversion based on the filtered current video block.

2. The method of claim 1, wherein the one or multiple previously coded frames comprise a reference frame in at least one of:
a reference picture list (RPL) associated with the current video block,
a RPL associated with a current slice comprising the current video block,
a RPL associated with a current frame comprising the current video block,
a reference picture set (RPS) associated with the current video block,
a RPS associated with the current slice, or
a RPS associated with the current frame; and
wherein the one or multiple previously coded frames comprise at least one of:
a short-term reference frame of the current video block,
a short-term reference frame of the current slice, or
a short-term reference frame of the current frame; or
wherein the one or multiple previously coded frames comprise at least one of:
a long-term reference frame of the current video block,
a long-term reference frame of the current slice, or
a long-term reference frame of the current frame.

3. The method of claim 1, wherein the one or multiple previously coded frames comprise a frame stored in a decoded picture buffer (DPB) that is not a reference frame;
wherein at least one indicator is indicated in the bitstream to indicate the one or multiple previously coded frames;
wherein the method further comprising:
determining the one or multiple previously coded frames for the current video block.

4. The method of claim 3, wherein the at least one indicator comprises an indicator to indicate a reference picture list comprising the one or multiple previously coded frames; or
wherein the at least one indicator is indicated in the bitstream based on a condition; and
wherein the condition comprises at least one of:
the number of reference pictures included in a RPL associated with the current video block,
the number of reference pictures included in a RPL associated with a current slice comprising the current video block,
the number of reference pictures included in a RPL associated with a current frame comprising the current video block,
the number of reference pictures included in a RPS associated with the current video block,
the number of reference pictures included in a RPS associated with the current slice, or
the number of reference pictures included in a RPS associated with the current frame; or
wherein the condition comprises the number of decoded pictures included on a DPB.

5. The method of claim 3, wherein determining the one or multiple previously coded frames comprises:
determining the one or multiple previously coded frames from at least one previously coded frame in a DPB;
wherein determining the one or multiple previously coded frames comprises:
determining the one or multiple previously coded frames from at least one reference frame in list 0;
wherein determining the one or multiple previously coded frames comprises:
determining the one or multiple previously coded frames from at least one reference frame in list 1;
wherein determining the one or multiple previously coded frames comprises:
determining the one or multiple previously coded frames from reference frames in both list 0 and list 1;
wherein determining the one or multiple previously coded frames comprises:
determining the one or multiple previously coded frames from a reference frame closest to a current frame comprising the current video block; or
wherein determining the one or multiple previously coded frames comprises:
determining the one or multiple previously coded frames from a collocated frame.

6. The method of claim 5, wherein determining the one or multiple previously coded frames comprises:
determining the one or multiple previously coded frames from a reference frame with a reference index equal to K in a reference list; and
wherein the value of K is predefined; or
wherein the value of K is determined based on reference picture information.

7. The method of claim 5, wherein determining the one or multiple previously coded frames comprises:
determining the one or multiple previously coded frames based on decoded information;
wherein determining the one or multiple previously coded frames based on decoded information comprises:
determining the one or multiple previously coded frames as the top N most-frequently used reference frames for samples within at least one of:
a current slice comprising the current video block, or
a current frame comprising the current video block,
wherein N is a positive integer;
wherein determining the one or multiple previously coded frames based on decoded information comprises:
determining the one or multiple previously coded frames as the top N most-frequently used reference frames of each reference picture list for samples within at least one of:
a current slice comprising the current video block, or
a current frame comprising the current video block,
wherein N is a positive integer; or
wherein determining the one or multiple previously coded frames based on decoded information comprises:
determining the one or multiple previously coded frames as frames with top N smallest picture order count (POC) distances or absolute POC distances relative to a current frame comprising the current video block, wherein N is a positive integer.

8. The method of claim 1, wherein whether the first information is used to filter the current video block depends on decoded information of at least one region of the current video block; or
wherein the first information comprises at least one of:
reconstruction samples in the one or multiple previously coded frames, or
motion information associated with the one or multiple previously coded frames.

9. The method of claim 8, wherein whether the first information is used to filter the current video block depends on at least one of:
a type of a current slice comprising the current video block, or
a type of a current frame comprising the current video block;
wherein whether the first information is used to filter the current video block depends on an availability of reference frames for the current video block;
wherein whether the first information is used to filter the current video block depends on at least one of:
reference picture information, or
picture information in a DPB;
wherein whether the first information is used to filter the current video block depends on a temporal layer index associated with the current video block;
wherein the first information is used to filter the current video block if the current video block does not comprise a sample coded in a non-inter mode; or
wherein whether the first information is used to filter the current video block depends on at least one of:
a distortion between the current video block and a matching block for the current video block, or
a distortion between the current video block and a collocated block in a previously coded frame of the video.

10. The method of claim 9, wherein the first information is used to filter the current video block if at least one of the following is met:
the type of the current slice indicates an inter-coded slice, or
the type of the current frame indicates an inter-coded frame;
wherein the first information is used to filter the current video block if a smallest POC distance associated with the current video block is not greater than a threshold;
wherein the first information is used to filter the current video block if the current video block has a given temporal layer index;
wherein the non-inter mode comprises an intra mode;
wherein the non-inter mode comprises at least one of a set of coding modes consisting of:
an intra mode,
an intra block copy (IBC) mode, or
a Palette mode;
wherein the method further comprises:
performing motion estimation to determine the matching block from at least one previously coded frame of the video; or
wherein the first information is used to filter the current video block if the distortion is not larger than a threshold.

11. The method of claim 8, wherein the reconstruction samples comprise at least one of:
samples in at least one reference block for the current video block, or
samples in at least one collocated block for the current video block; or
wherein the reconstruction samples comprise samples in a region pointed by a motion vector; and
wherein the motion vector is different from a decoded motion vector associated with the current video block.

12. The method of claim 11, wherein a center of a collocated block of the at least one collocated block is located at the same horizontal and vertical position in a previously coded frame as that of the current video block in a current frame;
wherein the at least one reference block is determined by motion estimation;
wherein a reference block of the at least one reference block is determined by reusing at least one motion vector included in the current video block;
wherein at least one block of the at least one reference block and/or the at least one collocated block is the same size as the current video block; or
wherein at least one block of the at least one reference block and/or the at least one collocated block is larger than the current video block.

13. The method of claim 12, wherein the motion estimation is performed at an integer precision;
wherein the at least one motion vector is rounded to an integer precision;
wherein the reference block is located by adding an offset to the position of the current video block, wherein the offset is determined by the at least one motion vector;
wherein the at least one motion vector points to a previously coded frame comprising the reference block;
wherein the at least one motion vector is scaled to a previously coded frame comprising the reference block;
wherein the at least one block with the same size as the current video block is rounded and extended at at least one boundary to include more samples from a previously code frame; or
wherein a size of the extended area is indicated in the bitstream or is derived during decoding the current video block from the bitstream.

14. The method of claim 1, wherein the first information comprises at least one of:
two reference blocks for the current video block with one of the two reference blocks from the first reference frame in list 0 and the other one from the first reference frame in list 1, or
two collocated blocks for the current video block with one of the two collocated blocks from the first reference frame in list 0 and the other one from the first reference frame in list 1;
wherein the current video block is filtered further based on second information different from the first information, and the first and second information is fed to the machine learning model together or separately; or
wherein filtering the current video block is used for at least one of:
compression,
super-resolution,
inter prediction, or
virtual reference frame generation.

15. The method of claim 14, wherein the first and second information is organized to have the same size and concatenated together to be fed to the machine learning model;
wherein features are extracted from the first information through a separate convolutional branch of the machine learning model and the extracted features are combined with the second information or features extracted from the second information;
wherein the first information comprises at least one reference block and/or at least one collocated block for the current video block in the one or multiple previously coded frames, and the at least one reference block and/or at least one collocated block have a spatial dimension different from the second information;
wherein the machine learning model has a separate convolutional branch for extracting, from the at least one reference block and/or at least one collocated block, features with the same spatial dimension as the second information;
wherein the current video block together with at least one reference block and/or at least one collocated block in the one or multiple previously coded frames are fed to a motion alignment branch of the machine learning model and an output of the motion alignment branch is combined with the second information; or
wherein the current video block is super-resolved by using the machine learning model.

16. The method of claim 1, wherein usage of the first information by the machine learning model is indicated in the bitstream;
wherein usage of the first information by the machine learning model depends on coding information;
wherein the machine learning model comprises a neural network;
wherein the conversion includes encoding the target video block into the bitstream; or
wherein the conversion includes decoding the target video block from the bitstream.

17. The method of claim 16, wherein usage of the first information by the machine learning model is indicated in at least one of:
sequence parameter set (SPS),
picture parameter set (SPS),
adaptation parameter set (APS),
slice header,
picture header,
coding tree unit (CTU), or
coding unit (CU);
wherein the first information is applied to a luma component of the current video block by the machine learning model without be applied to a chroma component; or
wherein the first information is applied to both a luma component and a chroma component of the current video block by the machine learning model.

18. An apparatus for processing video data comprising a processor and a non-transitory memory with instructions thereon, wherein the instructions upon execution by the processor, cause the processor to:
filter, according to a machine learning model during a conversion between a current video block of a video and a bitstream of the video, the current video block based on first information associated with one or multiple previously coded frames of the video; and
perform the conversion based on the filtered current video block.

19. A non-transitory computer-readable storage medium storing instructions that cause a processor to perform a method performed by a video processing apparatus, wherein the method comprises:
filtering, according to a machine learning model during a conversion between a current video block of a video and a bitstream of the video, the current video block based on first information associated with one or multiple previously coded frames of the video; and
performing the conversion based on the filtered current video block.

20. A non-transitory computer-readable recording medium storing a bitstream of a video which is generated by a method performed by a video processing apparatus, wherein the method comprises:
filtering, according to a machine learning model, a current video block of the video based on first information associated with one or multiple previously coded frames of the video; and
generating the bitstream based on the filtered current video block.
